(19) United States
(12) Patent Application Publication
(10) Pub. No.: US 2025/0054118 A1
(43) Pub. Date: Feb. 13, 2025

(54) METHOD OF ENCODING/DECODING A FEATURE MAP

(71) Applicant: Electronics and Telecommunications Research Institute, Daejeon (KR)

(72) Inventors: Youn Hee KIM, Daejeon (KR); JooYoung LEE, Daejeon (KR); Se Yoon JEONG, Daejeon (KR); Jin Soo CHOI, Daejeon (KR); Jun Won KANG, Daejeon (KR)

(73) Assignee: Electronics and Telecommunications Research Institute, Daejeon (KR)

(21) Appl. No.: 18/797,916

(22) Filed: Aug. 8, 2024

(30) Foreign Application Priority Data
Aug. 9, 2023 (KR) 10-2023-0104425
Oct. 4, 2023 (KR) 10-2023-0132036
Jan. 15, 2024 (KR) 10-2024-0006357
May 14, 2024 (KR) 10-2024-0063445
Aug. 8, 2024 (KR) 10-2024-0106405

(51) Int. Cl. G06T 5/80; G06T 5/60

(52) U.S. Cl. CPC G06T 5/80; G06T 5/60; G06T 2207/20084

(57) ABSTRACT

A feature map decoding method according to the present disclosure may include decoding a metadata and the feature map; performing inverse conversion on a decoded feature map; and restoring features from inverse converted features. Here, a feature distortion compensation is performed on at least one of the decoded feature map, the inverse converted features or restored features.

### FIELD OF THE INVENTION

The present disclosure relates to a method of encoding/decoding a feature map and device therefor.

### DESCRIPTION OF THE RELATED ART

Traditionally, image encoding/decoding technology has improved to enhance image compression efficiency and image quality by considering the human visual system. However, in the future, image encoding/decoding technology is expected to be widely used in the fields of machine vision such as surveillance, intelligent transportation, smart city, or intelligent industry as well as human vision.

Accordingly, the development of image encoding/decoding technology that may obtain high-efficiency compression and recognition accuracy by simultaneously considering human vision and machine vision is required.

### DISCLOSURE

### Technical Problem

The present disclosure is to provide a method of encoding/decoding features extracted from an input image.

The present invention is to provide a method to compensate feature distortion occurred in feature reduction, feature conversion or feature encoding during encoding/decoding features.

The present invention is to provide a method to encode/decode information for compensating feature distortion.

The technical objects to be achieved by the present disclosure are not limited to the above-described technical objects, and other technical objects which are not described herein will be clearly understood by those skilled in the pertinent art from the following description.

### Technical Solution

A feature map decoding method according to the present disclosure may include decoding a metadata and the feature map; performing inverse conversion on a decoded feature map; and restoring features from inverse converted features. Here, a feature distortion compensation is performed on at least one of the decoded feature map, the inverse converted features or restored features.

In a feature map decoding method according to the present disclosure, the metadata comprises position information for the feature distortion compensation, and according to the position information for the feature distortion compensation, at least one of the decoded feature map, the inverse converted features or the restored features is selected as a target for the feature distortion compensation.

In a feature map decoding method according to the present disclosure, the position information represents an index or an identifier indicating one of a plurality of candidate positions.

In a feature map decoding method according to the present disclosure, the position information comprises at least one of a first flag indicating whether the feature distortion compensation is performed for the decoded feature map, a second flag indicating whether the feature distortion compensation is performed for the inverse converted features, and a third flag indicating whether the feature distortion compensation is performed for the restored features.

In a feature map decoding method according to the present disclosure, the feature distortion compensation is performed based on a feature distortion compensation parameter, and the metadata comprises feature distortion compensation parameter information for deriving the feature distortion compensation parameter.

In a feature map decoding method according to the present disclosure, the feature distortion compensation parameter information is decoded in a unit of a layer or a channel.

In a feature map decoding method according to the present disclosure, the feature distortion compensation parameter comprises a weight and an offset, the weight is set as a standard derivation of original features according to a normal distribution, and the offset is set as an average value of the original features.

In a feature map decoding method according to the present disclosure, the feature distortion compensation parameter comprises a scaling factor, and the scaling factor is derived based on at least one of a maximum value basis scaling factor or a minimum value basis scaling factor.

In a feature map decoding method according to the present disclosure, the scaling factor is derived based on a weighted sum of the maximum value basis scaling factor and the minimum value basis scaling factor.

In a feature map decoding method according to the present disclosure, the metadata further comprises information on a period during which the feature distortion compensation parameter is maintained.

A feature map encoding method according to the present disclosure may include generating reduced features by performing a feature reduction on original features; generating a feature map by converting the reduced features; and encoding the feature map and a metadata. Here, the method further comprises deriving a feature distortion compensation parameter from at least one of the original features, the reduced features or the feature map.

In a feature map encoding method according to the present disclosure, the metadata comprises position information for the feature distortion compensation, and the position information indication one from which the feature distortion compensation parameter is derived among at least one of the original features, the reduced features or the feature map.

In a feature map encoding method according to the present disclosure, the position information for the feature distortion compensation represents an index or an identifier indicating one of a plurality of candidate positions.

In a feature map encoding method according to the present disclosure, the position information for the feature distortion compensation comprises at least one of a first flag indicating whether the feature distortion compensation parameter is derived from the original features, a second flag indicating whether the feature distortion compensation parameter is derived from the reduced features or a third flag indicating whether the feature distortion compensation parameter is derived from the feature map.

In a feature map encoding method according to the present disclosure, the metadata comprises feature distortion compensation parameter information for deriving the feature distortion compensation parameter.

In a feature map encoding method according to the present disclosure, the feature distortion compensation parameter information is encoded in a unit of a layer or a channel.

In a feature map encoding method according to the present disclosure, the feature distortion compensation parameter comprises a weight and an offset, the weight is set as a standard derivation of the original features according to a normal distribution, and the offset is set as an average value of the original features.

In a feature map encoding method according to the present disclosure, the feature distortion compensation parameter comprises a scaling factor, and the scaling factor is derived based on at least one of a maximum value basis scaling factor or a minimum value basis scaling factor.

In a feature map encoding method according to the present disclosure, the scaling factor is derived based on a weighted sum of the maximum value basis scaling factor and the minimum value basis scaling factor.

Meanwhile, according to the present disclosure, a computer readable recording medium recording instructions for executing the feature decoding method, instructions for executing the feature encoding method or a bitstream generated by the feature encoding method may be provided.

### Advantageous Effects

According to the present disclosure, an amount of data to be encoded/decoded may be reduced by encoding/decoding features derived from an input image instead of encoding/decoding the input image.

According to the present disclosure, performance of a machine task may be improved by compensating feature distortion occurred by features reduction, feature conversion or feature encoding.

According to the present disclosure, a method for efficiently encoding/decoding information for feature distortion may be provided.

### BRIEF DESCRIPTION OF DRAWINGS

FIG. 1 is a diagram of a machine task processing system comprising a feature encoder and a feature decoder according to an embodiment of the disclosure.

FIG. 2 is a detailed configuration diagram of the feature encoder illustrated in FIG. 1.

FIG. 3 is a detailed configuration diagram of the feature decoder illustrated in FIG. 1.

FIGS. 4 and 5 illustrate examples of generating a multi-scale feature group.

FIG. 6 illustrates a block diagram of a feature encoder and a feature decoder for compensating feature distortion according to one embodiment of the present disclosure.

FIG. 7 is a flowchart of a feature distortion compensation parameter encoding method according to an embodiment of the present disclosure.

FIG. 8 is a flowchart of a feature distortion compensation parameter decoding method according to an embodiment of the present disclosure.

FIG. 9 is for explaining an example of compensating for feature distortion occurring in a feature encoder.

FIG. 10 shows an example of deriving a scaling factor.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

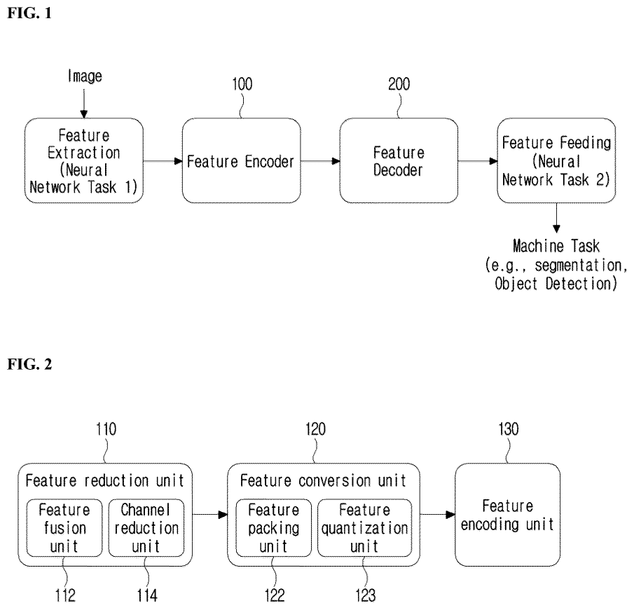

FIG. 1 is a diagram of a machine task processing system comprising a feature encoder and a feature decoder according to an embodiment of the disclosure.

Referring to FIG. 1, when features are extracted from the input image based on a neural network task, the extracted features are entered into the feature encoder 100.

The feature encoder 100 encodes the input features to generate a bitstream.

When the generated bitstream is transmitted to the feature decoder 200, the feature decoder 200 may decode the received bitstream and restore the features.

Meanwhile, based on the features restored from the video decoder (200), neural network tasks may be performed.

FIG. 2 is a detailed configuration diagram of the feature encoder illustrated in FIG. 1.

Referring to FIG. 2, the feature encoder (100) may include a feature reduction unit (110), a feature conversion unit (120), and a feature encoding unit (130).

The feature reduction unit (110) may perform a feature fusion and a channel reduction on an input multi-scale feature group. Here, the multi-scale feature group may composed of a group of features with multiple layers.

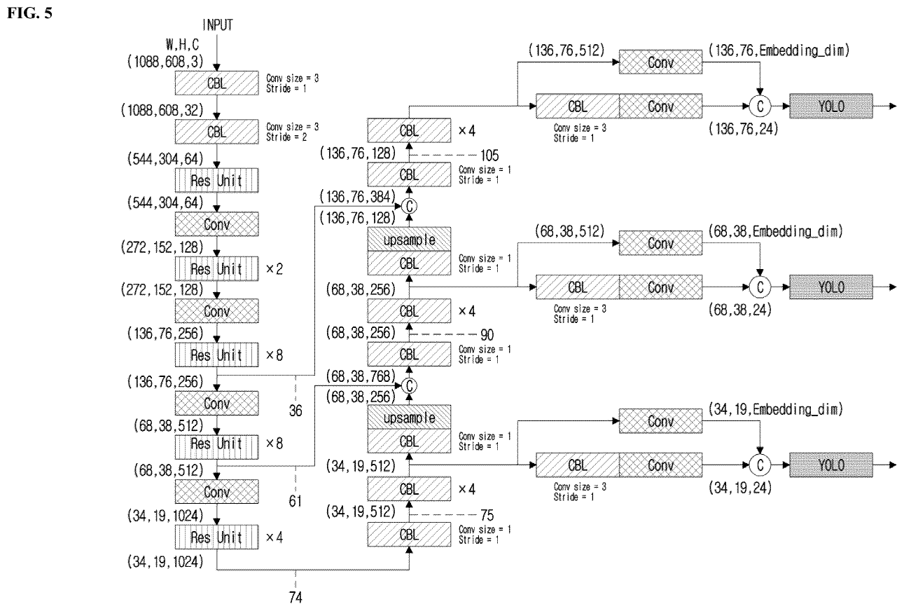

FIGS. 4 and 5 illustrate examples of generating a multi-scale feature group.

An example, illustrated in FIG. 4, shows that a multi-scale feature group consisting of multiple P-layers is generated through Faster/Mask R-CNN.

An example, illustrated in FIG. 5, shows that a multi-scale feature group consisting of multiple layers is generated through a JDE network.

As in the examples shown in FIGS. 4 and 5, resolutions of each of the layers constituting the multi-scale feature group may be different from each other, while the number of channels constituting each of the layers may be the same.

The feature reduction unit (110) may include a feature fusion unit (112) and a channel reduction unit (114).

The feature fusion unit (112) may reduce the number of layers by fusion of a multi-scale feature group into a single-scale feature group. That is, by performing feature fusion on an input multi-scale feature group, a single-scale feature group with multiple channels may be generated.

The channel reduction unit (114) may reduce the number of channels of the fused feature (i.e., the single-scale feature group). That is, by performing channel reduction on a single-scale feature group, a feature group with reduced channels may be generated. Meanwhile, the number of channels of the feature group on which channel reduction is performed may be equal to or less than the number of channels of a single-scale feature group.

Whether or not to perform the channel reduction process may be optional. Accordingly, the final data output from the feature reduction unit (110) may be a single-scale feature group generated through feature fusion.

A feature conversion unit (120) converts the data output from the channel reduction unit (114) into a format suitable for encoding. For example, the feature transformation unit (120) may perform feature packing and feature quantization.

The feature conversion unit (120) may include a feature packing unit (122) and a feature quantization unit (124).

A feature map may be generated by packing data output from the feature reduction unit (110) (i.e., a feature group with reduced channels or a single-scale feature group) into a single frame. That is, through feature packing, input data of 3 dimensions (i.e., channel, width, and height dimensions) may be converted into a feature map of 2 dimensions (i.e., width and height dimensions) with a single channel. Meanwhile, when packing features into a single frame, a feature may be rotated or flipped.

Feature quantization may be based on linear quantization using minimum and maximum values in the feature map. Accordingly, in order to perform dequantization in a feature decoder (200), the minimum and maximum values in the feature map may be encoded as metadata and transmitted. According to feature quantization, data with 32-bit floating point may be transformed into data with 10-bit integer.

The feature encoding unit (130) encodes the quantized feature map. Encoding of the feature map may be based on a general codec technology such as VVC, HEVC, or AV1, or may be based on a codec technology based on a neural network.

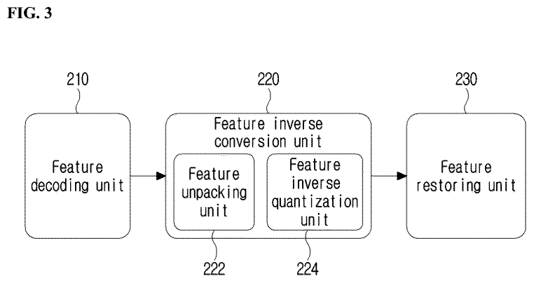

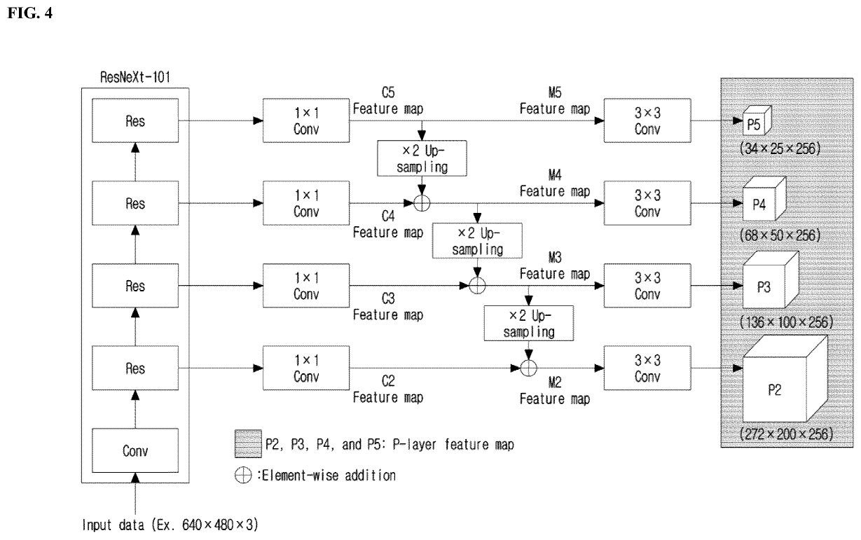

FIG. 3 is a detailed configuration diagram of the feature decoder illustrated in FIG. 1.

Referring to FIG. 3, the feature decoder (200) may include a feature decoding unit (210), a feature inverse conversion unit (220), and a feature restoration unit (230).

The feature decoding unit (210) decodes an encoded feature map. Decoding of the feature map may be based on a general codec technology such as VVC, HEVC, or AV1, or may be based on a codec technology based on a neural network.

The feature inverse conversion unit (220) may include a feature inverse quantization unit (224) and a feature unpacking unit (222).

The feature inverse quantization unit (224) performs inverse quantization on a decoded feature map. Specifically, inverse quantization on a decoded feature map may be performed based on minimum and maximum values in the feature map received from the feature encoder (100).

The feature unpacking unit (222) unpacks a feature map with a single-channel to generate feature data having three dimensions with multiple channels (e.g., a single-scale feature group). If a feature is packed into a feature map in a rotated or flipped state, the feature may be rotated or flipped in the opposite direction to generate a single-scale feature group.

The feature restoration unit (230) may restore a multi-scale feature group from a single-scale feature group according to a machine task to be performed.

Meanwhile, each functional unit (i.e., module) illustrated in FIGS. 2 and 3 may be implemented by a neural network, or may be implemented based on at least one of hardware and software. Meanwhile, the input/output data of each unit(i.e., module) may have a form of input/output data of a neural network.

In the process of encoding a feature, feature distortion may occur. And, feature distortion occurring during encoding a feature may cause a problem of deteriorating a performance of a machine task. Accordingly, the present disclosure provides a method for compensating feature distortion occurring in the process of encoding a feature.

FIG. 6 illustrates a block diagram of a feature encoder and a feature decoder for compensating feature distortion according to one embodiment of the present disclosure.

Referring to FIG. 6, the feature encoder (100) may further include a feature distortion compensation parameter derivation unit (140), and the feature decoder (200) may further include a feature distortion compensation unit (240).

A feature distortion may include at least one of the following:

Distortion of a feature due to PCA transform

Distortion of a feature due to feature fusion (e.g., MSFC conversion)

Distortion of a feature due to neural network (E2E) encoding

Distortion of a feature due to DCT transform

Distortion of a feature due to a conventional video encoding method (e.g., a 2D video encoding/decoding method (e.g., VVC))

Distortion of a feature due to compressing the neural network itself

Distortion due to a feature reduction unit (110)

Distortion due to a feature conversion unit (120)

Distortion due to a feature encoding unit (130)

To compensate for the above feature distortion, feature distortion compensation can be performed at least one of following feature decoding processes.

After PCA inverse transformation process

After inverse feature fusion conversion process (e.g., inverse MSFR conversion)

After neural network (E2E) decoding process

After DCT inverse transform

After conventional video decoding (VVC as an example)

After feature decoding process

After performing decoding on compressed neural network

After passing through a feature restoration unit (230)

After passing through a feature inverse conversion unit (220)

After passing through a feature decoding unit (210)

Referring to the configuration of the feature encoder (100) and the feature decoder (200) illustrated in FIG. 6, a feature distortion compensation method according to the present disclosure will be described in detail.

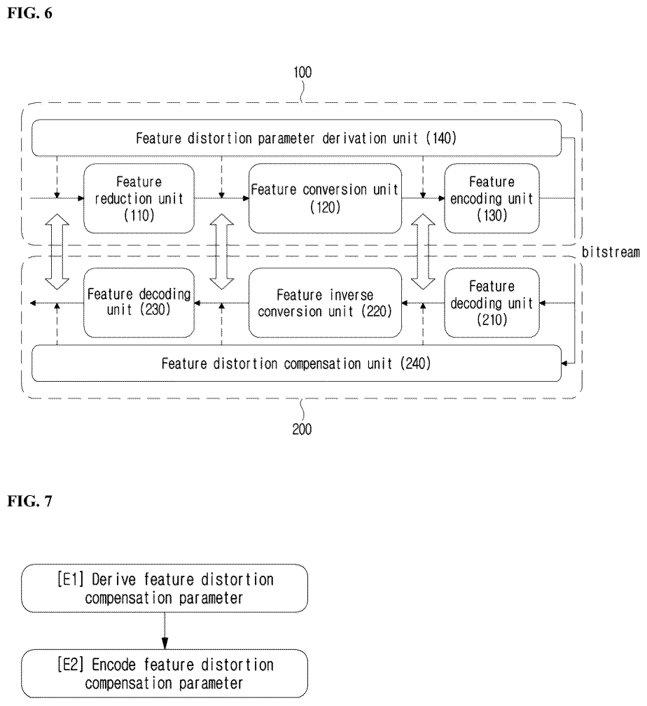

FIG. 7 is a flowchart of a feature distortion compensation parameter encoding method according to an embodiment of the present disclosure.

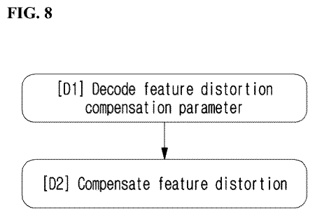

FIG. 8 is a flowchart of a feature distortion compensation parameter decoding method according to an embodiment of the present disclosure.

Hereinafter, each of the steps illustrated in FIG. 7 and FIG. 8 will be examined in detail.

### [E1] a Step of Deriving Feature Distortion Compensation Parameter

The feature encoder (100), specifically, the feature distortion compensation parameter extraction unit (140), can derive a feature distortion compensation parameter for compensating for feature distortion. A position where the feature distortion compensation parameter is derived and a position where the feature distortion is compensated may from a pair. Specifically, since the feature decoder (200) performs the reverse process of the feature encoder (100), the feature decoder (200) may compensate for feature errors or change the dynamic range at a position corresponding to the position where the feature distortion compensation parameter is derived.

FIG. 6 illustrates a correspondence between a location where a feature distortion compensation parameter is derived and a location where a feature distortion compensation is performed.

For example, if a feature distortion compensation parameter is derived based on the input data of the feature reduction unit (110) in the feature encoder (100), error correction may be performed on the output data of the feature restoration unit (230) in the feature decoder (200).

For example, if a feature distortion compensation parameter is derived based on the input data of the feature conversion unit (120) in the feature encoder (100), error correction may be performed on the output data of the feature inverse conversion unit (220) in the feature decoder (200).

For example, if a feature distortion compensation parameter is extracted based on the input data of the feature encoding unit (130) in the feature encoder (100), error correction may be performed on the output data of the feature decoding unit (210) in the feature decoder (200).

Meanwhile, a location for deriving the feature distortion compensation parameter and a location for compensating the feature distortion may be predefined in the encoder and decoder, respectively. For example, feature distortion compensation may be performed on at least one of the output data of the feature decoding unit (210), the output data of the feature inverse conversion unit (220), and the output data of the feature restoration unit (230) in the feature decoder (200).

Alternatively, information indicating one of the plurality of location candidates may be explicitly encoded/decoded as metadata. Here, the location candidate may indicate the location from which the feature distortion compensation parameter is derived and the location that the feature distortion compensation is performed on.

The type of the feature distortion compensation parameter may be different depending on the location from which the feature distortion compensation parameter is derived. Here, the type may indicate at least one of a size of the filter (i.e., the number of taps) or a shape of the filter.

In FIG. 6, it is exemplified that a 1:1 correspondence relationship is established between the location for deriving the feature distortion compensation parameter and the location that the feature distortion compensation is performed on. That is, in the example illustrated in FIG. 6, when the feature distortion compensation parameter is derived in the feature encoder (100), the feature distortion compensation is performed on the output data of the location in the feature decoder (200) that is the inverse corresponding location of the location where the feature distortion compensation parameter is derived. Unlike the illustrated example, the correspondence relationship between the feature distortion compensation parameter derived location and the feature distortion compensation location may be set differently from that illustrated in FIG. 6. That is, the feature compensation parameter derived at a specific location in the feature encoder (100) may be used to perform feature distortion compensation at an arbitrary location in the feature decoder (200). Here, the arbitrary location may be not only the corresponding location of the location where the feature distortion compensation parameter is derived, but also a non-corresponding location.

For example, a feature distortion compensation parameter derived based on input data of a feature reduction unit (110) in a feature encoder (100) may be used to compensate for feature distortion of output data of a feature inverse conversion unit (220) in a feature decoder (200).

For example, a feature distortion compensation parameter derived based on input data of a feature encoding unit (130) in a feature encoder (100) may be used to compensate for feature distortion of output data of a feature restoration unit (230) in a feature decoder (200).

Alternatively, a single feature distortion compensation parameter derived from a feature encoder (100) may be used to compensate for feature distortion at multiple locations in a feature decoder (200).

For example, a feature distortion compensation parameter derived based on input data of a feature reduction unit (110) in a feature encoder (100) may be used to compensate for feature distortion of each of output data of a feature inverse conversion unit (220) and output data of a feature restoration unit (230) in a feature decoder (200).

For example, a feature distortion compensation parameter derived based on the input data of the feature conversion unit (120) in the feature encoder (100) may be used to compensate for feature distortion for each of the output data of the feature inverse conversion unit (220) and the output data of the feature restoration unit (230) in the feature decoder (200).

For example, a feature distortion compensation parameter derived based on the input data of the feature conversion unit (130) in the feature encoder (100) may be used to compensate for feature distortion for each of the output data of the feature inverse transformation unit (220) and the output data of the feature restoration unit (230) in the feature decoder (200).

From a temporal perspective, a feature distortion compensation parameter may be derived in units of encoding units, frame units, multiple frame units, sequence units, or video units. Here, the encoding units can represent at least one of a slice, a tile, or a subpicture.

The multiple frame unit may represent a frame set with a predefined number of frames. As an example, the multiple frame unit may represent frames withing an intra period.

From a spatial perspective, a feature distortion compensation parameter may be derived in units of features, feature groups, or channels. Here, a feature group may be composed of one or more features. For example, a feature group may represent a feature layer.

Alternatively, when a feature map is encoded/decoded in units of blocks, a feature distortion compensation parameter may be derived in units of coding blocks, transform blocks, or coding tree units (CTUs).

At least one of a temporal unit or a spatial unit in which the feature distortion compensation parameter is encoded/decoded may be predefined in the feature encoder (100) and the feature decoder (200).

Alternatively, depending on the location where the feature distortion compensation parameter is derived, at least one of a unit in which the feature distortion compensation parameter is encoded/decoded or a derivation method of the feature distortion compensation parameter may be different.

For example, when the feature distortion compensation parameter is derived based on a feature set composed of multiple layers (i.e., a multi-scale feature set), the feature distortion compensation parameter may be derived for each layer and encoded/decoded individually for each layer.

Alternatively, when the feature distortion compensation parameter is derived based on a feature set composed of a single layer (e.g., a single-scale feature group), the feature distortion compensation parameter may be derived for each channel and encoded/decoded individually for each channel.

Alternatively, when the feature distortion compensation parameter is derived based on a single-dimensional feature map, the feature distortion compensation parameter may be derived for each encoding unit and encoded/decoded individually for each encoding unit.

When data having a channel form is used, a feature distortion compensation parameter may be derived based on feature channel distribution. As a specific example, a feature distortion compensation parameter may be derived based on the changed feature channel distribution between data input to a specific functional unit and data output from the specific functional unit. Here, the specific functional unit may be at least one of a feature encoding unit (130), a feature transformation unit (120), and a feature reduction unit (110).

According to one embodiment of the present disclosure, a feature distortion compensation parameter may be derived based on a feature channel distribution of at least one of data input to a feature encoding unit (130) or data output from the feature encoding unit (130).

For example, for one or more channels constituting data before feature encoding (i.e., data input to a feature encoding unit (130)) or data after feature encoding (i.e., data output from a feature encoding unit (130)), at least one of a maximum value, a minimum value, or an average value within a channel may be derived as a feature distortion compensation parameter. Here, the maximum value, the minimum value, or the average value represents a value related to a pixel value.

Meanwhile, in order to derive the maximum, minimum, or average value, all of the channels may be used, or some of the channels or a representative channel among the plurality of channels may be used.

Alternatively, the maximum, minimum, or average value of each channel may be derived, and the feature distortion compensation parameter may be derived according to the order of the channels calculated based on the maximum, minimum, or average value. For example, when the maximum, minimum, or average value among the plurality of channels is sorted in descending order, the feature distortion compensation parameter may be derived from the channel assigned the smallest index (i.e., the channel with the largest maximum, minimum, or average value). Conversely, the feature distortion compensation parameter may be derived from the channel with the smallest maximum, minimum, or average value, or with the median maximum, minimum, or average value.

For example, for one or more channels constituting data before feature encoding (i.e., data input to the feature encoding unit (130)) or data after feature encoding (i.e., data output from the feature encoding unit (130)), a feature distortion compensation parameter may be derived based on a channel-to-channel (i.e., inter channel) differential value. Here, the inter channel differential value may represent a difference between the maximum value, minimum value, or average value of a plurality of channels (e.g., two channels).

For example, for one or more channels constituting data before feature encoding (i.e., data input to the feature encoding unit (130)) or data after feature encoding (i.e., data output from the feature encoding unit (130), at least one distribution parameter among the maximum value, minimum value, or average value of each of the channels may be derived as a feature distortion compensation parameter of the corresponding channel. For example, when a normal distribution is applied, at least one of the average value or the standard deviation can be derived as a feature distortion compensation parameter. Alternatively, the standard deviation may be set as a feature distortion compensation parameter for encoding/decoding, while the average value is encoded/decoded as separate information.

Meanwhile, to derive the average value and standard deviation, all channels may be used, or some channels or a representative channel among a plurality of channels may be used.

According to one embodiment of the present disclosure, a feature distortion compensation parameter may be derived based on a distribution among at least one feature channel among data input to the feature conversion unit (120) or data output from the feature conversion unit (120).

For example, for one or more channels constituting data before feature conversion (i.e., data input to the feature conversion unit (120)) or data after feature conversion (i.e., data output from the feature conversion unit (120), at least one of a maximum value, a minimum value, or an average value within the channel may be derived as a feature distortion compensation parameter. Here, the maximum value, the minimum value, or the average value represents a value related to pixel values.

Meanwhile, in order to derive the maximum value, the minimum value, or the average value, all of the channels may be used, or some of the channels or a representative channel among the plurality of channels may be used.

Alternatively, the maximum value, the minimum value, or the average value of each channel may be derived, and the feature distortion compensation parameter may be derived according to the order among the channels calculated based on the maximum value, the minimum value, or the average value. For example, when sorting multiple channels in descending order of maximum, minimum, or average, the feature distortion compensation parameter can be derived from the channel assigned the smallest index (i.e., the channel with the largest maximum, minimum, or average value). Conversely, the feature distortion compensation parameter may be derived from the channel with the smallest maximum, minimum, or average value, or with the median maximum, minimum, or average value.

For example, for one or more channels constituting data before feature conversion (i.e., data input to the feature conversion unit (120)) or data after feature conversion (i.e., data output from the feature conversion unit (120)), the feature distortion compensation parameter can be derived based on the inter-channel differential value. Here, the inter-channel differential value may represent the difference between the maximum, minimum, or average values of each of the two channels.

For example, for one or more channels constituting data before feature conversion (i.e., data input to the feature conversion unit (120)) or data after feature conversion (i.e., data output from the feature conversion unit (120), at least one distribution parameter among the maximum value, minimum value, or average value of each channel may be derived as a feature distortion compensation parameter of the corresponding channel.

According to one embodiment of the present disclosure, a feature distortion compensation parameter may be derived based on a feature channel distribution of at least one of data input to a feature reduction unit (110) or data output from a feature reduction unit (110).

For example, for one or more channels constituting data before feature reduction (i.e., data input to a feature reduction unit (110)) or data after feature reduction (i.e., data output from a feature reduction unit (110)), at least one of a maximum value, a minimum value, or an average value within the channel may be derived as a feature distortion compensation parameter. Here, the maximum value, the minimum value, or the average value represents a value related to pixel values.

Meanwhile, in order to derive the maximum value, the minimum value, or the average value, all of the channels may be used, or some of the channels or a representative channel among a plurality of channels may be used. Alternatively, the maximum, minimum, or average values of each channel may be derived, and a feature distortion compensation parameter may be derived based on the order of the channels calculated based on the maximum, minimum, or average values. For example, when the maximum, minimum, or average values of a plurality of channels are sorted in descending order, the feature distortion compensation parameter may be derived from the channel assigned the smallest index (i.e., the channel with the largest maximum, minimum, or average value). Conversely, the feature distortion compensation parameter may be derived from the channel with the smallest maximum, minimum, or average value, or with the median maximum, minimum, or average value.

For example, a feature distortion compensation parameter may be derived based on the inter-channel differential values for one or more channels constituting data before feature reduction (i.e., data input to the feature reduction unit (110)) or data after feature reduction (i.e., data output from the feature reduction unit (110)). Here, the inter-channel difference value may represent the difference between the maximum, minimum, or average values of each of the two channels.

For example, for one or more channels constituting data before feature reduction (i.e., data input to the feature reduction unit (110)) or data after feature reduction (i.e., data output from the feature reduction unit (110)), at least one distribution parameter among the maximum, minimum, or average values of each of the channels may be derived as a feature distortion compensation parameter of the corresponding channel.

The type of the feature distortion compensation parameter may be determined differently depending on the factor causing the distortion of the feature. That is, one of a plurality of feature distortion compensation parameter types may be selected depending on the location where the feature distortion compensation parameter is derived. Here, a plurality of feature distortion compensation parameter types may be predefined in the feature encoder (100) and the feature decoder (200). For example, the feature distortion compensation parameter derived from the input data (i.e., feature map) of the feature encoding unit (130) may include at least one of a mean value or a standard deviation according to a normal distribution. On the other hand, the feature distortion compensation parameter derived from the input data (i.e., a single-scale feature group) of the feature conversion unit (120) or the input data (i.e., a multi-scale feature group) of the feature reduction unit (110) may include at least one of a weight or an offset.

As another example, a common feature distortion compensation parameter may be derived. The common feature distortion compensation parameter may be used to perform feature distortion compensation on output data in a specific functional unit within the feature decoder (200), regardless of where the feature distortion compensation parameter is derived.

The feature distortion compensation parameter may include at least one of a weight or an offset. Here, the weight may be a scaling factor for a scale operation.

Meanwhile, the feature distortion compensation parameter described in the present disclosure may be used to change the dynamic range of features. Specifically, in a feature encoder, after adjusting the dynamic range of features, features whose dynamic ranges have been adjusted may be encoded, and parameters for adjusting the dynamic range of features may be encoded as the feature distortion compensation parameter. For example, the adjustment of the dynamic range may be performed based on the average value and standard deviation of features, and each of the average value and standard deviation may be encoded as a feature distortion compensation parameter.

In a feature decoder, features may be restored through a refinement that changes the dynamic range of decoded features based on the feature distortion compensation parameter.

### [E2]/[D1] A Step of Encoding a Feature Distortion Compensation Parameter/A Step of Decoding Feature Distortion Compensation Parameter

In the feature encoder (100), information related to a feature distortion compensation parameter may be encoded. In addition, in the feature decoder (200), information related to a feature distortion compensation parameter transmitted from the feature encoder (100) may be decoded to determine whether feature distortion compensation should be performed or at least one of a feature distortion compensation parameter for the feature distortion compensation.

Meanwhile, information related to a feature distortion compensation parameter may be encoded/decoded for at least one of a sequence unit, a picture unit, a view unit, a layer unit, a channel unit, or an encoding unit.

Here, a sequence represents a set of multiple images, and a picture represents an input image from which features are extracted. For example, a sequence unit may represent a SPS (Sequence Parameter Set), and an image unit may represent a PPS (Picture Parameter Set).

For example, when a multi-scale feature group including multiple layers is derived from an input image, multiple layers in the multi-scale feature group may commonly refer to a PPS. That is, when information related to the feature distortion compensation parameter is encoded/decoded for a picture (i.e., in a PPS), a feature distortion compensation parameter may be commonly determined for the multiple layers by referring to a PPS.

The information related to the feature distortion compensation parameter may include at least one of information indicating whether the feature distortion compensation parameter exists, feature distortion compensation position information, or feature distortion compensation parameter information.

The information indicating whether the feature distortion compensation parameter exists may be a 1-bit flag. For example, if the value of the flag is 1, a feature distortion compensation parameter information may exist in the bitstream. On the other hand, if the value of the flag is 0, a feature distortion compensation parameter information is not exist in the bitstream. The flag may be encoded/decoded for at least one of a sequence unit, a picture unit, a view unit, a layer unit, a channel unit, or an encoding unit.

The feature distortion compensation position information may indicate at least one of a position where the feature distortion compensation parameter is derived or a position where feature distortion is compensated.

For example, the feature distortion compensation position information may be index information indicating one of a plurality of position candidates. Alternatively, the feature distortion compensation position information may be identification information indicating at least one of a plurality of position candidates. Table 1 illustrates a syntax structure that includes information indicating the feature distortion compensation location.

| | Descriptor |
|---|---|
| feat_seq_parameter_set_rbsp ( ) { | |
| ... | |
| num_ecs_sets | u(2) |
| for( i=0; i<num_ecs_sets;i+ +){ | |
| ecs_apply_location_id | u(2) |
| } | |
| ... | |
| } | |

In Table 1, the syntax num_ecs_sets indicates the number of locations (i.e., esc_apply_location_id) where feature distortion compensation is performed. The syntax num_ecs_sets may be 0 or an integer greater than 0.

The value of the syntax num_ecs_sets being 0 indicates that feature distortion compensation is not performed in the feature decoder (200). In this case, encoding/decoding of information indicating the feature distortion compensation location and the feature distortion compensation parameter information may be omitted.

When the value of the syntax num_ecs_sets is greater than 0, the syntax esc_apply_location_id indicating the location where feature distortion compensation is performed in the feature decoder (200) may be encoded/decoded.

The syntax ecs_apply_location_id may indicate an identifier of the location where feature distortion compensation is performed. The number of ecs_apply_location_id may be encoded/decoded as many as the number of locations where feature distortion compensation is performed, as indicated by the value of the syntax num_ecs_sets. In the above example, the information indicating the feature distortion compensation location is signaled through the sequence parameter set (i.e., feature_SPS). However, the information indicating the feature distortion compensation location may also be signaled through the picture parameter set (i.e., feature_PPS).

In another example, multiple location candidates may be selected among of a plurality of location candidates. In this case, one index indicating a combination of the multiple location candidates may be encoded/decoded, or multiple indexes/identifiers may be encoded/decoded to indicate the multiple location candidates. Alternatively, for each of the multiple location candidates, or for at least one of the multiple location candidates, information indicating whether feature distortion compensation is performed at the corresponding location may be explicitly encoded/decoded. The information may be a 1-bit flag.

For example, a first flag indicating whether feature distortion compensation is performed on the output data of the feature restoration unit (230) may be encoded/decoded. If the first flag is true, it indicates that feature distortion compensation is performed on the output data of the feature restoration unit (230). In this case, feature distortion compensation may be performed on the output data of the feature restoration unit (230) using a feature distortion compensation parameter derived based on the input data of the feature reduction unit (110). On the other hand, if the first flag is false, it indicates that feature distortion compensation is not performed on the output data of the feature restoration unit (230).

For example, a second flag indicating whether feature distortion compensation is performed on the output data of the feature inverse conversion unit (220) may be encoded/decoded. If the second flag is true, it indicates that feature distortion compensation is performed on the output data of the feature inverse conversion unit (220). In this case, feature distortion compensation may be performed on the output data of the feature inverse conversion unit (220) using the feature distortion compensation parameter derived based on the input data of the feature conversion unit (120). On the other hand, if the second flag is false, it indicates that feature distortion compensation is not performed on the output data of the feature inverse conversion unit (220).

For example, a third flag indicating whether feature distortion compensation is performed on the output data of the feature decoding unit (210) may be encoded/decoded. If the third flag is true, it indicates that feature distortion compensation is performed on the output data of the feature decoding unit (210). In this case, feature distortion compensation may be performed on the output data of the feature decoding unit (210) using the feature distortion compensation parameter derived based on the input data of the feature encoding unit (130). On the other hand, if the third flag is false, it indicates that feature distortion compensation is not performed on the output data of the feature decoding unit (210).

Only one or two of the first to third flags may be encoded/decoded. Feature distortion compensation may not be performed on the position corresponding to the flag that is not decoded.

Meanwhile, if feature distortion compensation is performed only once in the feature decoder (200), encoding/decoding of one of the first to third flags may be determined dependently on another.

For example, if it is assumed that decoding is performed in the order of the second flag and the first flag, the first flag may be encoded/decoded only when the second flag indicates that feature distortion compensation is not performed. On the other hand, if the second flag indicates that feature distortion compensation is performed, encoding/decoding of the first flag is omitted, and the value of the first flag may be inferred to indicate that feature distortion compensation is not performed at the corresponding position.

The feature distortion compensation parameter information may include information for deriving the value of the feature distortion compensation parameter.

Table 2 illustrates a syntax structure including feature distortion compensation parameter information.

TABLE 2

| | Descriptor |
|---|---|
| feature_pic_parameter_set_rbsp( ) { | |
| ... | |
| for( i=0; i<num_ecs_sets;i+ +){ | |
| for (j = 0; j <= num_feature_layers; j+ +) { | |
| ecs_parameter[i][j] | f(32) |
| } | |
| } | |
| ... | |
| } | |

In the example of Table 2, variable i represents an identifier of a position where feature distortion compensation is performed. That is, when feature distortion compensation is performed at multiple positions, feature distortion compensation parameter information, i.e., syntax esc_parameter, may be encoded/decoded for each of the multiple positions.

Variable j represents an index of a layer constituting a feature set. That is, when a feature group is composed of multiple layers, feature distortion compensation parameter information, i.e., syntax esc_parameter, may be encoded/decoded for each of the layers.

Accordingly, syntax ecs_parameter[i][j] may represent a feature distortion compensation parameter of a layer with index j in the feature group corresponding to the position with identifier j.

For example, syntax ecs_parameter may represent a value of one of a weight or an offset which is a kind of a feature distortion compensation parameter.

For example, under a normal distribution, esc_parameter may represent the standard deviation.

Meanwhile, when a weight and an offset are used for feature distortion compensation, information indicating the value of the weight and information indicating the value of the offset may be encoded/decoded, respectively.

For example, by extending the embodiment of Table 2, syntax ecs_parameter_weight[i][j] indicating the value of the weight and syntax ecs_parameter_offset[i][j] indicating the value of the offset may be encoded/decoded, respectively.

Meanwhile, a feature distortion compensation parameter may be encoded/decoded in units of channels.

Alternatively, feature distortion compensation parameter commonly applied to multiple layers may be encoded/decoded through a picture parameter set (i.e., feature_PPS).

Instead of directly encoding/decoding the value of the weight or offset, indirect information for deriving the value of the weight or offset may be encoded/decoded.

For example, feature distortion compensation parameter information may include an index that identifies one of multiple predefined candidate values. For example, at least one of an index specifying to one of the plurality of weight candidates or an index specifying to one of the plurality of offset candidates may be encoded/decoded.

Meanwhile, at least one of the number or configuration of weight candidates and/or offset candidates may be different depending on the location where feature distortion compensation is performed.

As another example, at the decoder side, at least one of the weights or offsets may be derived in the same manner as the encoder. In this case, the feature distortion compensation parameter information may include information for deriving the weights or offsets at the decoder side. As an example, the feature distortion compensation parameter information may include at least one of the weight information or the standard deviation for the weighted sum of the maximum value-based scaling factor and the minimum value-based scaling factor.

At the decoder side, at least one of the weights or offsets may be derived based on the feature distortion compensation parameter information and at least one of the average value, maximum value, minimum value, or median value of the decoded feature map. The method of deriving the weight or offset at the decoder side will be described later.

Meanwhile, information indicating the period at which the feature distortion compensation parameter is encoded/decoded may be explicitly encoded/decoded. For example, information indicating the number of frames in which a feature distortion compensation parameter to be encoded/decoded are maintained may be encoded/decoded. The feature distortion compensation parameter derived based on the feature distortion compensation parameter information may be used for frames indicated by the period information. When encoding/decoding for frames indicated by the period information is completed, new feature distortion compensation parameter information may be encoded/decoded.

Information indicating whether to reuse the value of the feature distortion compensation parameter used in the previous unit may be encoded/decoded. For example, the information may be a 1-bit flag.

If the flag indicates that the feature distortion compensation parameter used in the previous unit is reused, encoding/decoding of the feature distortion compensation parameter information may be omitted. On the other hand, if the flag indicates that the feature distortion compensation parameter used in the previous unit is not reused, information of the feature distortion compensation parameter may be explicitly encoded/decoded.

Here, the previous unit may represent a unit from which the feature distortion compensation parameter was derived previously on the same time axis. For example, if the feature distortion compensation parameter is encoded/decoded in units of layers, the previous unit may represent a layer previous to the current layer.

Alternatively, the previous unit may be a corresponding encoding/decoding target existing on a different time axis from the current encoding/decoding target. For example, when the feature distortion compensation parameter is derived in units of frames, the previous unit may be the previous frame (e.g., the frame located at (t−1) on the time axis) of the current frame located at t on the time axis.

Meanwhile, instead of directly encoding/decoding the value of the feature compensation parameter in the current unit, information indicating the difference between the feature distortion compensation parameter used in the previous unit and the feature distortion compensation parameter used in the current unit may be encoded/decoded.

Information indicating a type of the feature or feature distortion compensation parameter may be encoded/decoded. For example, the type of the feature distortion compensation parameter may indicate whether the feature distortion compensation parameter consists of only an offset or whether the feature distortion compensation parameter is a linear parameter (e.g., a weight and an offset).

Alternatively, the type of the feature distortion compensation parameter may be adaptively determined depending on the location where the feature distortion compensation is performed (i.e., the location where the feature distortion compensation parameter is derived).

Meanwhile, the feature encoder (100) may further encode/decode feature value information. The feature value information may include at least one of a maximum value, a minimum value, an average value, a median value, a most frequent value, a difference value between a maximum value and a minimum value, or a difference value between a maximum value and an average value among the original feature values. Here, the original feature value may be derived from an original feature map, a single-scale feature group, or a multi-scale feature group depending on the location where the feature distortion compensation parameter is derived.

The feature value information may be used for feature dequantization. Also, the feature value information may be used to derive a feature distortion compensation parameter on the decoder side, or to perform feature distortion compensation. Alternatively, a common feature distortion compensation parameter may be encoded/decoded regardless of where feature distortion compensation is performed.

### [D2] A Step of Compensating Feature Distortion

The feature decoder (200), specifically, the feature distortion compensation unit (240), may perform feature distortion compensation based on a position where feature distortion compensation is to be performed and a feature distortion compensation parameter corresponding to the position.

The feature distortion compensation may be performed in units of features, feature groups, or channels.

Alternatively, when the feature map is encoded/decoded in block units, the feature distortion compensation may be performed in units of coding blocks, transform blocks, or CTUs.

According to one embodiment of the present disclosure, by performing feature distortion compensation on output data (i.e., a decoded feature map) from the feature decoding unit (210), the distribution of the feature that has changed due to feature encoding may be corrected.

Specifically, the feature distortion compensation parameter and the feature value information may be used to compensate for feature distortion of the decoded feature map. Here, the feature value information may include at least one of the maximum value, minimum value, average value, difference between maximum and minimum value, or difference between maximum and average value among the original feature values.

In addition, in the case of a normal distribution, feature distortion for a decoded feature map may be compensated using the average value and standard deviation.

According to one embodiment of the present disclosure, by performing feature distortion compensation on the output data of the feature inverse conversion unit (220) (i.e., inversely converted feature (i.e., single-scale feature group)), the distribution of the feature changed due to feature conversion may be corrected.

Specifically, the feature distortion compensation parameter and feature value information may be used to compensate for feature distortion of a single-scale feature group. Here, the feature value information may include at least one of the maximum value, minimum value, average value, difference between maximum and minimum value, or difference between maximum and average value among the original feature values. According to one embodiment of the present disclosure, by performing feature distortion compensation on output data of a feature restoration unit (230) (i.e., restored features (i.e., multi-scale feature set)), a distribution of features changed due to feature reduction may be corrected.

Specifically, feature distortion of a multi-scale feature group may be compensated for using the feature distortion compensation parameter and feature value information. Here, the feature value information can include at least one of a maximum value, a minimum value, an average value, a difference between a maximum value and a minimum value, or a difference between a maximum value and an average value among original feature values.

Next, a detailed description of the specific process for compensating for feature distortion will be provided.

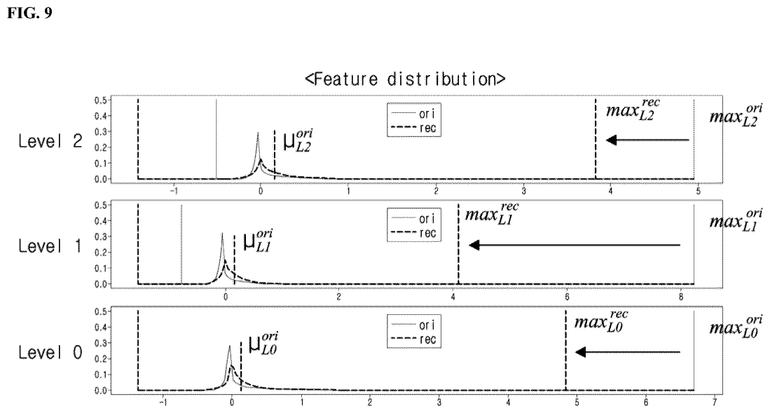

FIG. 9 is for explaining an example of compensating for feature distortion occurring in a feature encoder.

When the PCA transformation function is used in the feature encoder (100), distortion occurs during the feature encoding process, in which the distribution of the original features and the distribution of the decoded features become different, as in the example shown in FIG. 9. To compensate for such feature distortion, an offset may be used. Specifically, a refined feature may be generated by adding an offset to a restored feature. Here, the restored feature may represent a decoded feature (i.e., a feature included in a decoded feature map), an inversely converted feature (i.e., a feature included in a single-scale feature group), or a restored feature (i.e., a feature included in a multi-scale feature group), depending on the location where feature distortion compensation is performed.

Alternatively, a weight may be multiplied to the restored feature to compensate for feature distortion. Here, multiplying the weights may be replaced by a shifting operation using a scaling factor. In addition, an offset may be added to the result of multiplying the weight to generate a refined feature.

As another example, a refined feature may be generated by transforming the distribution of restored features to be similar to the distribution of original features based on at least one of feature value information and the feature distortion compensation parameter. As an example, equation 1 shows an example of deriving a refined feature.

$$\begin{matrix}{feature}_{z}^{recone} = \frac{{feature}^{recon} − {u}^{recon}}{{σ}^{org}} \\ {feature}^{refine} = {feature}_{z}^{recon} {σ}^{org} + {u}^{org}\end{matrix} \qquad [ Equation 1 ]$$

In equation 1, feature^{recon} represents the value of the restored feature, and u^{recon} represents the average value of the restored features. In addition, σ^{org} represents the standard deviation of the original features, and u^{org} represents the average value of the original features. By using the standard deviation of the original features, a temporary restored feature feature^{recon}_{z} may be generated, and then, by applying a weight and offset to the temporary restored feature, a refined feature feature^{refine} may be generated.

Meanwhile, in equation 1, it is exemplified that the standard deviation of the original features is set as the weight, and the average value of the original features is set as the offset.

As described above, the weight and/or offset may be explicitly encoded/decoded as a feature distortion compensation parameter.

As another example, the weight and/or offset may be derived at the decoder side with the same way as in the encoder.

For example, the scaling factor may be derived based on the values of the original features and the values of the restored features.

Specifically, the scaling factor may be derived based on at least one of a maximum-based scaling factor and a minimum-based scaling factor. Equation 2 shows an example of deriving a maximum-based scaling factor.

$$[ Equation 2 ]$$

$$ALT 1 ) : \frac{Abs ( Maximum value of original features - Average value of original features )}{Abs ( Maximum value of restored features - Average value of restored features )}$$

$$ALT 2 ) : \frac{Abs ( Maximum value of original features )}{Abs ( Maximum value of restored features )}$$

$$ALT 3 ) : \frac{Abs ( Maximum value of original features - Most frequent value of original features )}{Abs ( Maximum value of restored features - Most frequent value of restored features )}$$

Using one of ALT1) to ALT3) in the equation 2, a maximum value-based scaling factor may be derived.

Equation 3 shows an example of deriving a minimum value-based scaling factor.

$$[ Equation 3 ]$$

$$ALT 1 ) : \frac{Abs ( Minimum value of original features - Average value of original features )}{Abs ( Minimum value of restored features - )}$$

$$ALT 2 ) : \frac{Abs ( Minimum value of original features )}{Abs ( Minimum value of restored features )}$$

$$ALT 3 ) : \frac{Abs ( Minimum value of original features - Most frequent value of original features )}{Abs ( Minimum value of restored features - Most frequent value of restored features )}$$

A minimum value-based scaling factor can be derived by using one of ALT1) to ALT3) of the above mathematical expression 3.

Either the maximum-based scaling factor or the minimum-based scaling factor may be set as the scaling factor (i.e., weight) for feature distortion compensation.

Alternatively, the weighted result between the maximum-based scaling factor and the minimum-based scaling factor may be set as the scaling factor for feature distortion compensation.

Equation 4 shows an example of deriving a scaling factor for feature distortion compensation.

$$Scale = α {Scale}_{max} + β {Scale}_{min} \qquad [ Equation 4 ]$$

As in the example of mathematical expression 4, the scaling factor Scale may be derived by assigning the first weight α to the maximum value-based scaling factor Scaleₘₐₓ and the second weight β to the minimum value-based scaling factor Scaleₘᵢₙ.

Meanwhile, the first weight α and the second weight β may be determined by experimental results and may be predefined in the feature encoder (100) and the feature decoder (200).

Alternatively, information on the first weight α and the second weight β may be explicitly encoded/decoded.

As another example, the scaling factor may be derived based on the ratio between the distribution parameter of the original feature and the distribution parameter of the restored feature. Here, the distribution parameter may include at least one of the average value or the standard deviation.

As an example, the ratio between the average value of the original feature and the average value of the restored feature may be set as the scaling factor. That is, the restored feature may be multiplied by the scaling factor to generate a refined feature.

Alternatively, the ratio between the standard deviation of the original feature and the standard deviation of the decoded feature may be set as the scaling factor. That is, the restored feature may be multiplied by the scaling factor to generate a refined feature.

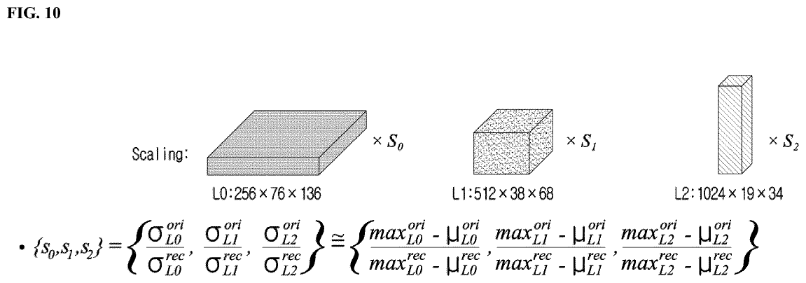

FIG. 10 shows an example of deriving a scaling factor.

In FIG. 10, σ^{ori}_{LX} represents the standard deviation of the LX layer constituting the original feature, and σ^{rec}_{LX} represents the standard deviation of the LX layer constituting the restored feature. max^{ori}_{LX} represents the maximum value of the LX layer constituting the original feature, and max^{rec}_{LX} represents the maximum value of the LX layer constituting the restored feature.

As in the illustrated example, the ratio between standard deviations or the ratio between maximum values may be set as the scaling factor. Meanwhile, in the illustrated example, it is illustrated that the scaling factor is derived in units of layers.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method of decoding a features map, the method comprising:
decoding a metadata and the feature map;
performing inverse conversion on a decoded feature map; and
restoring features from inverse converted features,
wherein a feature distortion compensation is performed on at least one of the decoded feature map, the inverse converted features or restored features.

2. The method of claim 1, wherein the metadata comprises position information for the feature distortion compensation, and
wherein according to the position information for the feature distortion compensation, at least one of the decoded feature map, the inverse converted features or the restored features is selected as a target for the feature distortion compensation.

3. The method of claim 2, wherein the position information represents an index or an identifier indicating one of a plurality of candidate positions.

4. The method of claim 2, wherein the position information comprises at least one of a first flag indicating whether the feature distortion compensation is performed for the decoded feature map, a second flag indicating whether the feature distortion compensation is performed for the inverse converted features, and a third flag indicating whether the feature distortion compensation is performed for the restored features.

5. The method of claim 1, wherein the feature distortion compensation is performed based on a feature distortion compensation parameter, and
wherein the metadata comprises feature distortion compensation parameter information for deriving the feature distortion compensation parameter.

6. The method of claim 5, wherein the feature distortion compensation parameter information is decoded in a unit of a layer or a channel.

7. The method of claim 5, wherein the feature distortion compensation parameter comprises a weight and an offset,
wherein the weight is set as a standard derivation of original features according to a normal distribution, and
wherein the offset is set as an average value of the original features.

8. The method of claim 5, wherein the feature distortion compensation parameter comprises a scaling factor, and
wherein the scaling factor is derived based on at least one of a maximum value basis scaling factor or a minimum value basis scaling factor.

9. The method of claim 8, wherein the scaling factor is derived based on a weighted sum of the maximum value basis scaling factor and the minimum value basis scaling factor.

10. The method of claim 5, wherein the metadata further comprises information on a period during which the feature distortion compensation parameter is maintained.

11. A method of encoding a feature map, the method comprising:
generating reduced features by performing a feature reduction on original features;
generating a feature map by converting the reduced features; and
encoding the feature map and a metadata,
wherein the method further comprises deriving a feature distortion compensation parameter from at least one of the original features, the reduced features or the feature map.

12. The method of claim 11, wherein the metadata comprises position information for the feature distortion compensation, and
wherein the position information indication one from which the feature distortion compensation parameter is derived among at least one of the original features, the reduced features or the feature map.

13. The method of claim 12, wherein the position information for the feature distortion compensation represents an index or an identifier indicating one of a plurality of candidate positions.

14. The method of claim 11, wherein the position information for the feature distortion compensation comprises at least one of a first flag indicating whether the feature distortion compensation parameter is derived from the original features, a second flag indicating whether the feature distortion compensation parameter is derived from the reduced features or a third flag indicating whether the feature distortion compensation parameter is derived from the feature map.

15. The method of claim 11, wherein the metadata comprises feature distortion compensation parameter information for deriving the feature distortion compensation parameter.

16. The method of claim 11, wherein the feature distortion compensation parameter information is encoded in a unit of a layer or a channel.

17. The method of claim 15, wherein the feature distortion compensation parameter comprises a weight and an offset,
wherein the weight is set as a standard derivation of the original features according to a normal distribution, and
wherein the offset is set as an average value of the original features.

18. The method of claim 15, wherein the feature distortion compensation parameter comprises a scaling factor, and
wherein the scaling factor is derived based on at least one of a maximum value basis scaling factor or a minimum value basis scaling factor.

19. The method of claim 18, wherein the scaling factor is derived based on a weighted sum of the maximum value basis scaling factor and the minimum value basis scaling factor.

20. A computer-readable non-transitory recording medium storing a method of encoding a feature map, wherein the method comprises:
generating reduced features by performing a feature reduction on original features;
generating a feature map by converting the reduced features; and
encoding the feature map and a metadata,
wherein the method further comprises deriving a feature distortion compensation parameter from at least one of the original features, the reduced features or the feature map.
